(19) United States
(12) Patent Application Publication
(10) Pub. No.: US 2025/0131045 A1
(43) Pub. Date: Apr. 24, 2025

(54) SNIPPET INFORMATION GENERATION METHOD AND APPARATUS, SEARCH RESULT DISPLAY METHOD AND APPARATUS, DEVICE, AND MEDIUM

(71) Applicant: DOUYIN VISION (BEIJING) CO., LTD., Shijingshan District, Beijing (CN)

(72) Inventors: Shuangshuang JIANG, Beijing (CN); Chao QIAO, Beijing (CN)

(21) Appl. No.: 18/836,569

(22) PCT Filed: May 25, 2023
(86) PCT No.: PCT/CN2023/096323

§ 371 Date: Aug. 7, 2024

(30) Foreign Application Priority Data
Jun. 16, 2022 (CN) 202210689553.7

(51) Int. Cl. G06F 16/9038

(52) U.S. Cl. CPC G06F 16/9038

(57) ABSTRACT

The present invention relates to a snippet information generation method and apparatus, a search result display method and apparatus, a device, and a medium. The search result display method includes: in response to search content, obtaining a first research result; displaying, in a search result page, snippet information corresponding to the first search result, wherein the snippet information is generated on the basis of detailed content and snippet attributes of the first search result, the snippet attributes comprise at least one of the snippet row number, the snippet area size, and snippet typesetting information, and the snippet attributes are determined on the basis of key content matched with the search content in the detailed content.

### CROSS-REFERENCE TO RELATED APPLICATIONS

The present application is based on the application with a CN application number of 202210689553.7 and the filing date of Jun. 16, 2022, and claims its priority. The disclosure of this CN application as a whole is incorporated into the present application herein by reference.

### TECHNICAL FIELD

The present disclosure relates to that technical field of search, in particular to snippet information generation method and apparatus, search result display method and apparatus, device, and medium.

### BACKGROUND

In related art, the comprehensive search engine can obtain a plurality of search results corresponding to a search content input by users according to the search content. Then, part of the text and/or part of the pictures that hit the keywords contained in the search content are selected from the text content (also called detailed content) of each search result. Then, according to the snippet requirements of search results, such as no more than 3 pictures and no more than 3 lines of text, the selected text and/or pictures are sorted out to generate a snippet corresponding to each search result for users to preview.

### SUMMARY

In a first aspect, the present disclosure provides a search result display method, comprising:
acquiring a first search result in response to search content;
displaying snippet information corresponding to the first search result on a search result page, wherein: the snippet information is generated based on detailed content and a snippet attribute of the first search result; the snippet attribute comprises at least one of a snippet line number, a snippet area size or snippet typesetting information; and the snippet attribute is determined based on key content matching the search content in the detailed content.

In a second aspect, the present disclosure also provides a snippet information generation method, comprising:
acquiring a first search result corresponding to search content;
determining a target snippet attribute of the first search result based on key content of the first search result, wherein: the target snippet attribute comprises at least one of a snippet line number, a snippet size or snippet typesetting area information, and the key content is content matching the search content in detailed content of the first search result;
performing information processing on the detailed content based on the target snippet attribute to generate snippet information corresponding to the first search result.

In a third aspect, the present disclosure also provides a search result display apparatus, comprising:
a first search result acquisition module for acquiring a first search result in response to search content;
a snippet information display module for displaying snippet information corresponding to the first search result on a search result page, wherein: the snippet information is generated based on detailed content and a snippet attribute of the first search result; the snippet attribute comprises at least one of a snippet line number, a snippet area size or snippet typesetting information; and the snippet attribute is determined based on key content matching the search content in the detailed content.

In a fourth aspect, the present disclosure also provides a snippet information generation apparatus, comprising:
a first search result acquisition module for acquiring a first search result corresponding to search content;
a target snippet attribute determination module for determining a target snippet attribute of the first search result based on key content of the first search result, wherein: the target snippet attribute comprises at least one of a snippet line number, a snippet area size or snippet typesetting information, and the key content is content matching the search content in detailed content of the first search result;
a snippet information generation module for performing information processing on the detailed content based on the target snippet attribute to generate snippet information corresponding to the first search result.

In a fifth aspect, the present disclosure provides an electronic device, comprising:
a processor;
a memory for storing executable instructions;
wherein the processor is for reading the executable instructions from the memory and executing the executable instructions to implement the search result display method or the snippet information generation method described in any embodiment of the present disclosure.

In a sixth aspect, the present disclosure provides a computer-readable storage medium storing a computer program which, when executed by a processor, causes the processor to implement the search result display method or the snippet information generation method described in any embodiment of the present disclosure.

In a seventh aspect, the present disclosure provides a computer program, comprising: instructions that, when executed by a processor, cause the processor to execute the search result display method or the snippet information generation method described in any embodiment of the present disclosure.

### BRIEF DESCRIPTION OF THE DRAWINGS

The above and other features, advantages, and aspects of embodiments of the present disclosure will become more apparent by referring to the following detailed description when taken in combination with the accompanying drawings. Throughout the drawings, the same or similar reference signs refer to the same or similar elements. It should be understood that the drawings are schematic and that the originals and elements are not necessarily drawn to scale.

FIG. 1 is a flow diagram of a search result display method provided by an embodiment of the present disclosure;

FIG. 2 is a display schematic diagram for displaying snippet information on a search result page provided by an embodiment of the present disclosure;

FIG. 3 is another display schematic diagram for displaying snippet information on a search result page provided by an embodiment of the present disclosure;

FIG. 4 is yet another display schematic diagram for displaying snippet information on a search result page provided by an embodiment of the present disclosure;

FIG. 5 is still another display schematic diagram for displaying snippet information on a search result page provided by an embodiment of the present disclosure;

FIG. 6 is a schematic flow diagram of a snippet information generation method provided by an embodiment of the present disclosure;

FIG. 7 is a schematic structural diagram of a search result display apparatus provided by an embodiment of the present disclosure;

FIG. 8 is a schematic structural diagram of a snippet information generation apparatus provided by an embodiment of the present disclosure;

FIG. 9 is a schematic structural diagram of an electronic device provided by an embodiment of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be embodied in various forms and should not be construed as limited to the embodiments set forth herein, but rather these embodiments are provided for a more complete and thorough understanding of the present disclosure. It should be understood that the drawings and embodiments of the present disclosure are for illustration purposes only and are not intended to limit the scope of the disclosure.

It should be understood that the various steps recited in the method embodiments of the present disclosure may be performed in a different order, and/or performed in parallel. Moreover, the method embodiments may include additional steps and/or omit performing the illustrated steps. The scope of the present disclosure is not limited in this respect.

The term “comprise” and variations thereof as used herein are intended to be open-ended, i.e., “comprise but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the following description.

It should be noted that the terms “first”, “second”, and the like in the present disclosure are only used for distinguishing different devices, modules or units, and are not used for limiting the order of functions performed by the devices, modules or units or interdependence thereof.

It is noted that references to “a” or “a plurality of” mentioned in the present disclosure are intended to be illustrative rather than limiting, and those skilled in the art will appreciate that unless otherwise clearly indicated in the context, they should be understood as “one or more”.

The names of messages or information exchanged between devices in the embodiments of the present disclosure are for illustrative purposes only, and are not intended to limit the scope of the messages or information.

At present, the snippet information of search result provided by the search engine can only extract and display the detailed content of the search result according to the specified number of pictures and specified number of text lines. However, on one hand, the snippet content displayed by such snippet information cannot display more key content of the search result due to the limitation of the number of pictures and the number of text lines, which makes the information content of the snippet information low and cannot meet the user's search and screening requirements, and thus cannot provide better preview guidance for the user to screen suitable search results, so that the user needs to switch frequently between the landing page of the search result and the search result page, thus reducing the user's search efficiency and information acquisition efficiency. On the other hand, when the key content of the search result is short, due to the requirements of the number of pictures and number of text lines, some worthless content irrelevant to the search content will be added to the snippet information, which will cause information interference to the user for screening the search results and also reduce the user's search efficiency and information acquisition efficiency.

Based on the above situation, the embodiment of the present disclosure provides a solution for generating snippet information and displaying a search result, to dynamically generate and display snippet information that can display the detailed content of the search result more appropriately according to the key content that matches the search content in the detailed content of the search result, so that the snippet information can directly meet the search requirements of the user and improve the user's screening efficiency of the search results and information acquisition efficiency.

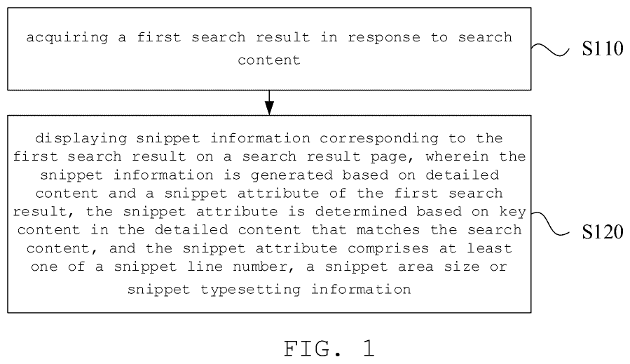

First, the search result display method provided by the embodiment of the present disclosure will be described with reference to FIGS. 1-5.

The search result display method provided by the embodiment of the present disclosure can be executed by a search result display apparatus, which can be implemented by means of software and/or hardware, and which can be integrated in an electronic device installed with front-end search related applications. The electronic device may include, but is not limited to, a mobile terminal such as a smart phone, a notebook computer, a personal digital assistant (PDA), a tablet personal computer (Tablet PC), a portable multimedia player (PMP), a vehicle-mounted terminal (such as a vehicle navigation terminal), a wearable device, etc., and a fixed terminal such as a digital TV, a desktop computer, etc.

FIG. 1 shows a flow diagram of a search result display method provided by an embodiment of the present disclosure. As shown in FIG. 1, the search result display method may comprise the following steps.

S110, acquiring a first search result in response to search content.

The search content refers to the content that requires a search engine to perform a search operation and feed back a search result, which can be a keyword, or a long sentence or a short sentence. The first search result is a piece of search result that is obtained by searching the search content and needs to generate snippet information. The snippet information refers to the snippet generated by the detailed content of search result.

Specifically, the electronic device can receive the search content input by the user on the search page of a specific application or a specific website.

In some embodiments, the user can input any form of information such as text, voice and image in the search box on the search page, so that the electronic device can use the text corresponding to the information input by the user as the search content input by the user.

In other embodiments, a plurality of recommended search contents can be displayed on the search page, and the user can select from the displayed recommended search contents, so that the electronic device can use the recommended search content selected by the user as the search content. For example, according to the historical search behavior data authorized by the user, the search field that the user is concerned about or the popular search field in the current time period is determined. Then, some recommended search contents in the search field determined above are displayed in the search box, below the search box or on other areas of the search page. Users can choose a recommended search content that they are interested in from these recommended search contents as the search content input by users.

After receiving the search content input by the user, the electronic device can send it to a server. The server performs a search operation on the received search content to obtain comprehensive search results, that is, a plurality of search results that are comprehensively sorted according to some rules. Then, the server feeds back the comprehensive search results to the electronic device. The electronic device can determine any one of the comprehensive search results as the first search result, and can also determine any one of the search results to be displayed on the screen as the first search result.

S120, displaying snippet information corresponding to the first search result on a search result page, wherein the snippet information is generated based on detailed content and a snippet attribute of the first search result, the snippet attribute is determined based on key content in the detailed content that matches the search content, and the snippet attribute comprises at least one of a snippet line number, a snippet area size or snippet typesetting information.

Attribute is information that represents the related attributes of the snippet information, and may be, for example, it may be a snippet line number representing the text length of the snippet information, a snippet area size representing the display area occupied by snippet information, snippet typesetting information representing the drawing/text typesetting style of snippet information, or it may be two or three of the snippet line number, the snippet area size and the snippet typesetting information.

In the embodiment of the present disclosure, the snippet attribute can be dynamically determined according to the key content that matches the search content in the detailed content comprised in the first search result, that is, the snippet attribute is adapted to the key content, so that the subsequent snippet information can reflect the detailed content of the first search result more accurately and comprehensively. The above-mentioned key content can be obtained by extracting information from the detailed content through a reading comprehension model in related technology.

Specifically, the snippet information in the embodiment of the present disclosure is obtained by extracting and sorting out the detailed content of the first search result according to the snippet attribute. The electronic device displays the snippet information corresponding to the first search result on the search result page to preview the detailed content of the first search result. According to this process, the electronic device can determine a plurality of first search results and their snippet information, and display them on the search result page. In this way, the snippet information displayed on the search result page is dynamically generated according to the detailed content of the first search result corresponding to the snippet information, and the snippet line number and/or picture number displayed by the snippet information can be different, rather than fixed.

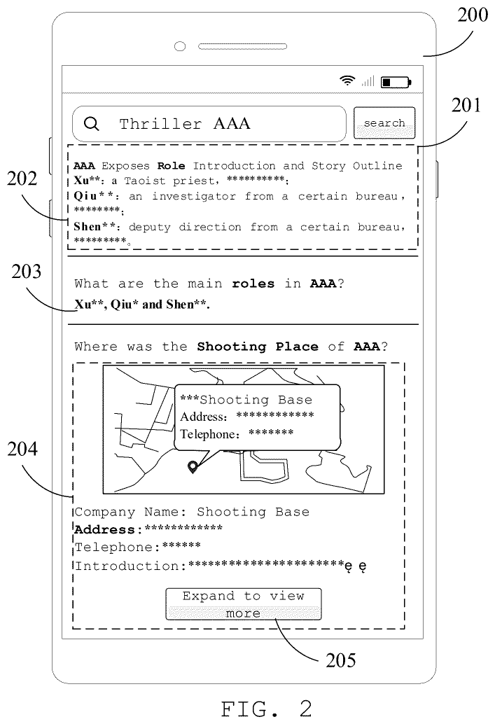

Referring to FIG. 2, for the search content “thriller AAA”, an electronic device 200 displays a plurality of result titles and snippet information of the first search result on a search result page 201, and at least one of the snippet line number, the snippet area size or the snippet typesetting information of these snippet information is different. For example, snippet information 202 with the result title of “AAA Exposes Role Introduction and Story Outline” is three lines of text, with a medium snippet area size, and the snippet typesetting information is three paragraphs of text beginning with three characters; snippet information 203 with the result title of “What are the Main Roles of AAA?” is a line of text, with a smallest snippet area size, and the snippet typesetting information is one paragraph of text; snippet information 204 with the result title of “Where was the Shooting Place of AAA?” contains four lines of text and a picture containing map location information, with a largest snippet area size, and the snippet typesetting information is a large picture and four lines of text, and the four lines of text are displayed in segments in four information dimensions of company name, address, telephone number and introduction. It can be seen that each snippet information is dynamically generated according to the key content of the first search result, and search answers matching the result title are comprehensively displayed, which can directly meet the search requirements of the result title without jumping to the landing page.

According to the above explanation, the snippet information comprises the key content of the first search result as much as possible, so the snippet information can meet the search requirements of users to a great extent, so that the jumping times of users clicking on the first search result to enter the landing page of their detailed content are reduced, thus improving the efficiency of users in obtaining information and the efficiency of users in screening search results.

It should be noted that the generation of snippet information can be executed by an electronic device, or it can be generated by a server and then fed back to the electronic device. For the process of determining the snippet attribute and the process of generating the snippet information, please refer to the description of related embodiments of the subsequent snippet information generation method.

In some embodiments, the snippet attribute is determined based on a comprehensive quality index value corresponding to the key content and a content length of the key content.

The comprehensive quality index value: used to characterize a satisfaction degree of the first search result to the search requirements, which can be obtained by the server through the search result scoring/ranking model in related art. The length of the above content is the length of the key content, such as the length of text or the number of pictures.

Specifically, the snippet attribute in this embodiment is dynamically determined according to the comprehensive quality index value and the content length of the first search result. For example, the higher the comprehensive quality index value and the longer the content length of the first search result, the more snippet lines in the snippet attribute of the first search result, the larger the snippet area size, and the more complicated the snippet typesetting information, so that the more and clearer the information displayed by the snippet information.

In some embodiments, S120 comprises displaying snippet information in a target style on a search result page.

The target style matches the snippet attribute, and is used to define the display style of the snippet information.

Specifically, the electronic device determines the target style adapted to the snippet information according to the snippet information. For example, the text line number in the target style is consistent with the snippet line number, the proportion of the display area occupied by pictures and texts in the target style is determined according to the snippet area size and the importance of the pictures/texts, and the graphic and texts typesetting style in the target style is consistent with the snippet typesetting information. Then, the electronic device displays the snippet information on the search result page according to the target style.

In some embodiments, displaying snippet information in a target style on a search result page comprises: displaying target text that successfully matches the search content in the snippet information in a first preset style on the search result page, and displaying other texts in the snippet information in a second preset style.

The display effect of the first preset style is stronger than the display effect of the second preset style, and other texts are texts except the target text in the snippet information.

Specifically, in order to further improve the information acquisition efficiency, in this embodiment, the target text matching the search content in the snippet information is highlighted, that is, the target text is displayed in the first preset style with more prominent display effect, and other texts are displayed in the second preset style with weaker display effect.

With continued reference to FIG. 2, the result titles corresponding to the snippet information 202 and the snippet information 203 both display the keyword “AAA” and the keyword “Role” matching the search content in bold, while the snippet information 202 and the snippet information 203 both display the role names “Xu**”, “Qiu**” and “Shen**” in bold. Meanwhile, the result title corresponding to the snippet information 204 displays “AAA” and the keyword “shooting place” matching the search content in bold, while the snippet information 204 displays “address: ************” in bold.

In some embodiments, displaying snippet information in a target style on a search result page comprises: in response to the key content comprising a plurality of key pictures, and an information amount of each key picture being greater than that of key text comprised in the key content, or in response to the search content corresponding to a picture search intention and the key content comprising a plurality of key pictures, displaying a target number of key pictures comprised in the snippet information in a target display area corresponding to the snippet information on the search result page.

The key pictures refer to pictures in the key content that meet the search requirements of the search content and have good quality. The key text refers to text that matches the search content. The target display area is a display area on the search result page for displaying the snippet information of the first search result. The target number is the number of key pictures comprised in the snippet information, which is greater than a preset number. The preset number is a default number of pictures in the snippet information in the relatedart, and can be, for example, 1 to 3.

Specifically, in response to the electronic device or the server determining that the search content is an image search intention, it can be determined that the image can better meet the user's search requirements than the text. Or, in response to the key pictures in the key content of the search result being better than the key text, that is, the information amount of a plurality of key pictures comprised in the key content is greater than that of the key text comprised therein, it can also be determined that the pictures can better meet the user's search requirements than the text. In this case, the electronic device or server can select a target number of key pictures from a plurality of key pictures in the key content as the main snippet content of the snippet information according to a plurality of dimensions comprising the picture quality of the key pictures and the matching degree with the search content, and appropriately reduce the content of the key text, so as to generate the snippet information. Then, the electronic device or the server can display the target number of key pictures and key text in the target display area on the search result page. These key pictures can be displayed in the form of a picture set consisting of a plurality of pictures, or in the form that all the key pictures are arranged and displayed by reducing the size of the pictures.

In an example, an area proportion of the display area of each key picture in the snippet information on the target display area exceeds a preset proportion.

The preset proportion is a preset graphic and text display proportion, for example, it can be a default graphic display proportion in related art.

Specifically, based on the above explanation, the number of key pictures in the snippet information has increased, so in response to the electronic device displaying the snippet information on the search result page, it can dynamically expand the display area of the pictures, so that an area proportion of the display area of each key picture in the display area of the snippet information exceeds a preset proportion, to display more key pictures.

In an example, displaying a target number of key pictures comprised in the snippet information in a target display area corresponding to the snippet information on the search result page comprises: displaying the target number of key pictures in the target display area in a display style that slides along a first preset direction to switch.

The first preset direction (also called the first reference direction) is a preset sliding direction, such as the left-right sliding direction or the up-and-down sliding direction.

Specifically, the electronic device can display a target number of key pictures according to the display style that slides along the first preset direction to switch, to improve the convenience for viewing the key pictures.

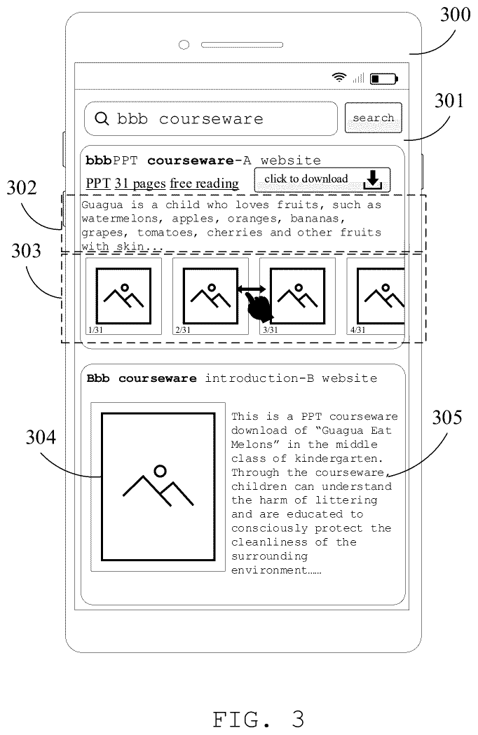

As shown in FIG. 3, for the search content “bbb courseware”, an electronic device 300 displays a result title “bbbPPT Courseware-A website” and snippet information of the first search result from the A website on a search result page 301. Two lines of key text 302 and a plurality of key pictures 303 that can be slid left and right are displayed in the snippet information, and a display area of the key pictures 303 is larger than that of the key text 302.

In other embodiments, displaying snippet information in a target style on a search result page comprises: in response to the key content comprising a key picture and the key picture meeting search requirements corresponding to the search content, displaying the key picture in a target display area corresponding to the snippet information on the search result page, and an area proportion of a picture display area of the key picture in the target display area exceeding a preset proportion.

Specifically, in response to the electronic device or the server determining that one of the key pictures comprised in the key content can directly meet the search requirements, that is, the matching degree of one key picture with the search content reaches a preset matching degree, then the electronic device or the server can take the successfully matched key picture as the main snippet content of the snippet information. At the same time, the area proportion of the key picture in the target display area of the snippet information is expanded. For example, in response to the electronic device displaying the snippet information, it can display the successfully matched key picture as a large picture mode, so that the area proportion of the picture display area of the key picture in the target display area of the snippet information exceeds a preset proportion. In this way, users can get the required search result more quickly through the successfully matched key picture, which further improves the information acquisition efficiency.

With continued reference to FIG. 3, the electronic device 300 can also display a result title “bbb Courseware Introduction-B Website” and snippet information of the first search result from the B website on the search result page 301. In this snippet information, a key picture 304 displayed in a large picture mode and a paragraph of key text 305 which are successfully matched with the search content “bbb courseware” are displayed.

In yet other embodiments, displaying snippet information in a target style on a search result page comprises: in response to an information amount of key text comprised in the key content being greater than that of key pictures comprised in the key content, displaying the key text in a target display area of the snippet information on the search result page according to an information display dimension corresponding to the key text, and displaying at least one key picture according to a preset picture position.

The information display dimension is a block dimension of text information, for example, it can be the core key of the search answer that conforms to the search content, and it can also be an information dimension such as contact phone number, address, name and so on. The preset picture position is a preset picture display position, which can be determined according to the picture size or the information content in the picture. For example, if the picture size is larger or the information content in the picture is more and matches the search content, the preset picture position can be above the text and the picture is displayed in a large picture mode. On the contrary, if the picture size is smaller or the picture information content is smaller and the matching degree with the search content is lower, the preset picture position can be below or on the side of the text to assist the text content.

Specifically, in response to the key text in the key content being better (such as higher information content, higher matching degree with the search content, etc.) than the key picture, the snippet information comprises more key text. At this time, in order to improve the organization of snippet information so that users can obtain information more clearly and quickly, the electronic device can reconstruct the key text, that is, display the key text according to the information display dimension corresponding to the key text, and display the key picture comprised in the snippet information according to the preset picture position.

With continued reference to FIG. 2, the snippet information 202 with a result title of “AAA Exposes Role Introduction and Story Outline” reconstructs the key text in the snippet information 202 into three paragraphs by taking three roles as information display dimensions, and each paragraph of text is expanded for its corresponding information display dimension (i.e. role).

Continuing to refer to FIG. 2, snippet information 204 with the result title of “Where was the Shooting Place of AAA?” comprises a large map picture and has a high matching degree with the search content, so the preset picture position is above the key text, so the map picture is displayed above the key text in a large picture mode. Then, the key text in the snippet information 204 is reconstructed into four paragraphs by taking the company name, address and telephone number as the information display dimensions, and each paragraph is expanded for information display dimension (i.e. company name, address, telephone number, etc.) corresponding to the each paragraph.

The search result display method provided by the embodiment of the present disclosure can determine an appropriate snippet attribute for the search result according to the key content matched with the search content in the detailed content of the search result, and generate and display the snippet information of the search result according to the snippet attribute and the detailed content of the search result, so that the snippet information of each search result can be dynamically adjusted according to the key content of the corresponding search result. Therefore, the user can know the key content of the search result without jumping to the landing page of the search result, so that the snippet information can directly meet the user's search requirements, which improves the preview guidance effect of the snippet information on the detailed content of the search result, thereby improving the user's screening efficiency of search results and the information acquisition efficiency.

In some embodiments, displaying snippet information in a target style on a search result page comprises: displaying an all-snippet viewing control at a display position of the snippet information in response to complete snippet content of the snippet information exceeding the snippet line number and/or the snippet area size; and after displaying the snippet information in the target style on the search result page, displaying the complete snippet content at a first preset position on the search result page in response to a trigger operation of the all-snippet viewing control.

The first preset position (also called the “first reference position”) is a preset display position, which can be a floating window on the search result page or an immediate surrounding area of the display area of the snippet information.

Specifically, because the search result page needs to display a plurality of pieces of introduction information of search results (such as result titles and snippet information), and the display screen of the electronic device is limited, the display area of each piece of introduction information cannot be expanded indefinitely. Based on this, a maximum critical value can be set for the snippet attribute, that is, a snippet attribute threshold, to limit the snippet attribute determined according to the comprehensive quality index value and the content length of the first search result. Therefore, it can be understood that the snippet line number and the snippet area size in the snippet attribute are both limited.

Based on the above description, if the snippet line number or the snippet area size corresponding to the complete snippet content determined by the electronic device or the server exceeds the snippet line number or the snippet area size in the snippet attribute, then the electronic device takes the snippet attribute threshold as the display constraint, and only displays part of the complete snippet content, hides part of the content exceeding the snippet attribute threshold, and displays the all-snippet viewing control in the display area of the snippet information.

In response to a user performing a trigger operation such as clicking, voice control trigger, eye movement control trigger, etc. on the all-snippet viewing control, the electronic device can detect the trigger operation and display the complete snippet content at the first preset position on the search result page in response to the trigger operation.

With continued reference to FIG. 2, the electronic device 200 displays an all-snippet viewing control 205 with the control content of “Expand to view more” at the bottom of the display area of the snippet information 204. In response to the user clicks the all-snippet viewing control 205, the electronic device 200 can create a floating window on the search result page, and display the complete snippet content corresponding to the snippet information 204 in the floating window, wherein the complete snippet content comprises the whole content of the displayed part of the content and the part of the content that is hidden because it exceeds the snippet attribute threshold. Alternatively, in response to the trigger operation that the user clicks the all-snippet viewing control 205, the electronic device 200 moves the display position of introduction information of another first search result immediately below the snippet information 204 down by a distance of an area size occupied by the hidden part of content, and continues to display the hidden part of content in a vacant display area.

In some embodiments, in order to further improve the information content of the snippet information, and further improve the user's consumption efficiency of search results and the user's screening efficiency of each search result, more content of the detailed content of the first search result can be displayed in the snippet information, that is, the content that the user consumes more frequently in the detailed content is pre-positioned in the snippet information, thus shortening the path for the user to consume information.

In an example, displaying snippet information in a target style on a search result page comprises: displaying at least one of a resource download control, a resource use right identifier and a thumbnail in the detailed content in the target display area of the snippet information on the search result page. The resource download control is a control corresponding to a resource download link. The resource use right identifier is an identifier indicating the user's right to read, download and other consumption operations, such as free reading, charged downloading and so on. The thumbnail is a picture in which a key picture is reduced to a certain size.

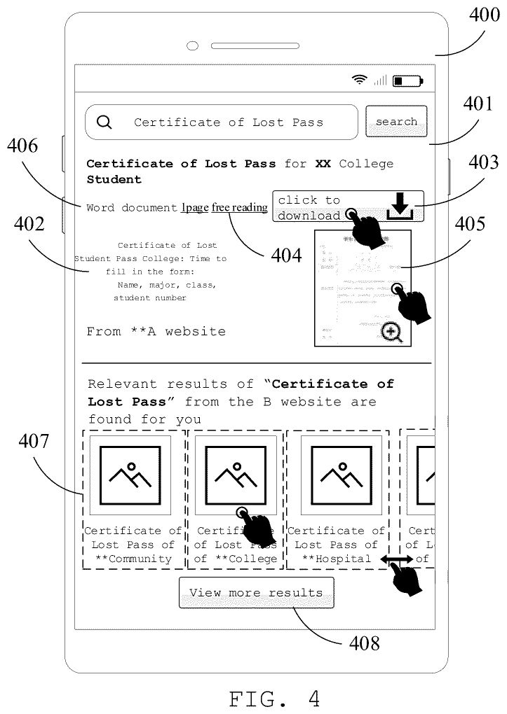

Referring to FIG. 4, for the search content “certificate of lost pass”, an electronic device 400 displays snippet information with the result title of “Certificate of Lost Pass for XX College Student” in the search result page 401. In this snippet information, in addition to displaying key text 402, there are also displayed a resource download control 403, a resource use right identifier 404 of “free reading”, a thumbnail 405 with reduced display size, a resource type 406 of “Word document”, a resource information amount of “one page” and so on.

In some embodiments, in response to the resource download control being displayed in the target display area, after displaying the snippet information in a target style on the search result page, the electronic device hides the resource download control in response to a trigger operation on the resource download control, and displays the resource download progress information at the display position of the resource download control.

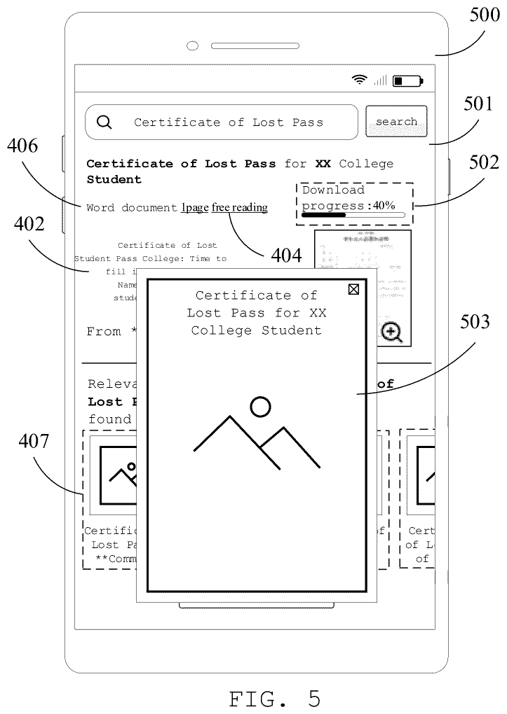

Specifically, with continued reference to FIG. 4, the user can trigger the resource download control 403 to directly download the document in the first search result. At this time, the electronic device 400 can switch the resource download control 403 to display the resource download progress information, such as a download progress bar and/or download percentage, and the display effect is shown in FIG. 5. In FIG. 5, the electronic device 500 may hide the resource download control at the display position of the resource download control and display resource download progress information 502.

In some embodiments, in response to the key content comprising a key picture, and the original display size of the key picture being larger than the snippet area size, the thumbnail corresponding to the key picture is displayed in the target display area.

Specifically, with continued reference to FIG. 4, the certification document in the detailed information of “Certificate of Lost Pass for XX College Student” can be displayed in the snippet information in the form of picture. However, the original display size of the certification document in the form of picture is obviously larger than the snippet area size in the snippet attribute. At this time, in order to display the key picture corresponding to the certification document in the snippet information, the electronic device will reduce the display size of the key picture, obtain the thumbnail 405 of the key picture, and display it in the display area of the snippet information on the search result page.

On the basis of the above embodiment, after displaying the snippet information in a target style on the search result page, the electronic device displays the key picture corresponding to the thumbnail at a second preset position on the search result page in response to the trigger operation on the thumbnail.

The second preset position (also called “second reference position”) is a preset display position, such as a floating window or panel control on the search result page.

Specifically, with continued reference to FIG. 4, in response to the electronic device displaying the thumbnail 405 for the first time, it can display relevant text prompts showing that an interactive operation can be performed to enlarge the thumbnail, or directly display a magnifying glass icon at a certain position (such as the lower right corner of FIG. 4) of the thumbnail 405 to prompt the user to view the picture with an enlarged display size of the thumbnail 405 through interactive operation. In response to the user triggering the thumbnail 405, the electronic device can display the key picture corresponding to the thumbnail 405 at the second preset position on the search result page 401, and the display effect is shown in FIG. 5. In FIG. 5, an electronic device 500 creates a floating window 503 on a search result page 501, and displays a key picture corresponding to the thumbnail 405 of FIG. 4 in the floating window 503.

In some embodiments, displaying snippet information in a target style on a search result page comprises: displaying a plurality of sub-snippets in a display style that slides along a second preset direction (also called “second reference direction”) to switch on the search result page.

A second search result is a search result obtained by the search engine directly according to the search content, and it has great correlation with the first search result. The sub-snippet refers to a snippet of a next level in the snippet information, wherein it comprises key text matching a key picture in the second search result and/or search content.

Specifically, in order to improve the information content of the search result page and the user's screening efficiency of search results, in this embodiment, a plurality of similar search results from the same source can be aggregated into one search result, that is, the first search result itself comprises a plurality of search results. For the first search result, the snippet information comprises sub-snippets corresponding to each aggregated second search result, and these sub-snippets are displayed in a display style that slides along the second preset direction to switch. The generation process of the sub-snippets is the same as that of the snippet information.

With continued reference to FIG. 4, the search result page 401 of the electronic device 400 also displays the introduction information of the first search result from the B website, which includes the result title of “Relevant results of ‘Certificate of Lost Pass’ from the B website are found for you” and a plurality of sub-snippets 407, each of which comprises a key picture and a short key text. And because the number of sub-snippets 407 is large, the electronic device 400 displays these sub-snippets 407 in a display mode of sliding left and right to switch.

For example, on the basis of the above-mentioned embodiment of the sub-snippets, a sub-snippet viewing control for viewing more sub-snippets is also displayed in the display area of the snippet information. As shown in FIG. 4, a sub-snippet viewing control 408 with the control text content of “View more results” is displayed in the area below each sub-snippet 407.

On the basis of the above example, the electronic device can display all the sub-snippets at a fourth preset position on the search result page in response to a trigger operation on the sub-snippet viewing control. The fourth preset position is a preset display position, which can be a floating window on the search result page or a new page.

Specifically, the electronic device can create a floating window or create a new page on the search result page in response to the user's trigger operation on the sub-snippet viewing control 408, and display all the sub-snippets in the floating window or on the new page.

In some embodiments, after displaying each sub-snippet on the search result page in a display style that slides along the second preset direction to switch, the electronic device can respond to the trigger operation on any sub-snippet, and display the detailed content of the second search result corresponding to the triggered sub-snippet at a third preset position (also called “third reference position”) on the search result page.

The third preset position is a preset display position, which can be a floating window on the search result page or a new page.

Specifically, the user can perform a trigger operation such as clicking on any one of the displayed sub-snippets, and the electronic device can create a floating window on the search result page in response to the trigger operation, and display the detailed content of the second search result corresponding to the triggered sub-snippet in the floating window. Alternatively, in response to the trigger operation, the electronic device jumps from the search result page to a new page, and displays the detailed content of the second search result corresponding to the triggered sub-snippet on the new page.

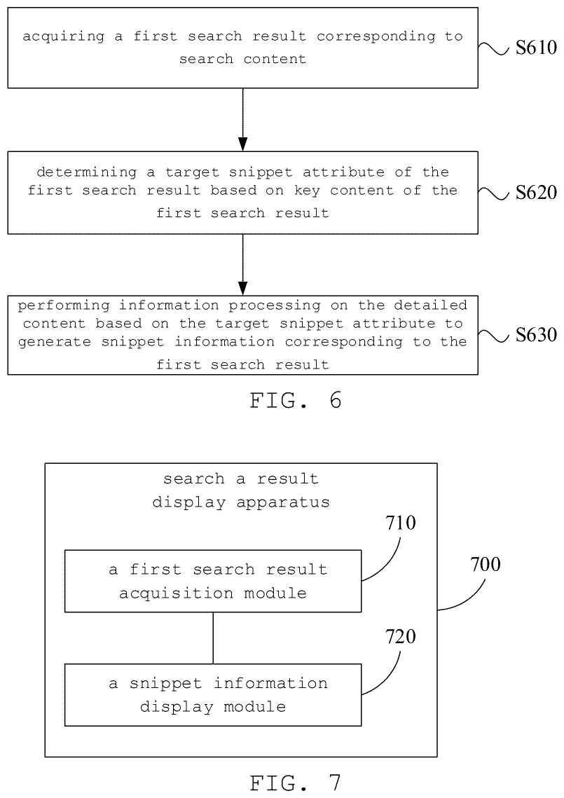

Next, the snippet information generation method provided by the embodiment of the present disclosure will be described with reference to FIG. 6.

The snippet information generation method provided by the embodiment of the present disclosure can be executed by a snippet information generation apparatus, which can be implemented by means of software and/or hardware, and which can be integrated in an electronic device installed with front-end search related applications or an electronic device executing back-end search functions. Among them, the electronic device installed with front-end search related applications can include, but is not limited to, a mobile terminal such as a smart phone, a notebook computer, a personal Digital Assistant (PDA), a tablet computer (Tablet PC), a portable multimedia player (PMP), a vehicle-mounted terminal (such as a vehicle-mounted navigation terminal), a wearable device, and a fixed terminal such as a digital television and a desktop computer. The electronic device performing the back-end search functions can be implemented as a single server or a server cluster.

FIG. 6 shows a schematic flow diagram of a snippet information generation method provided by an embodiment of the present disclosure. As shown in FIG. 6, the snippet information generation method may include the following steps.

S610, acquiring a first search result corresponding to search content.

Specifically, referring to the above description of S110, the electronic device can acquire the search content and first search result corresponding to the search content.

S620, determining a target snippet attribute of the first search result based on key content of the first search result.

The target snippet attribute comprises at least one of a snippet line number, a snippet area size or snippet typesetting information, and the key content is content that matches the search content in detailed content of the first search result.

Specifically, after acquiring the first search result, the electronic device extracts the key content from the detailed content of the first search result according to a relevant content extraction model. Then, according to the information such as the content type in the key content, the content length and content importance of different content types, the target snippet attribute adapting to the first search result is dynamically determined.

In some embodiments, S620 comprises: determining a target snippet attribute based on a comprehensive quality index value, a content length and a preset mapping relationship of the first search result. That is, the electronic device can pre-store a preset mapping relationship among the comprehensive quality index value, the content length and the snippet attribute, and a corresponding relationship among the comprehensive quality index value, the content length and the snippet attribute is recorded in the preset mapping relationship. Then, the electronic device takes the obtained comprehensive quality index value and content length of the first search result as indexes to query the preset mapping relationship to obtain a snippet attribute corresponding to the first search result as the target snippet attribute. This can improve the determination rate of the target snippet attribute to a certain extent.

In other embodiments, S620 comprises: adjusting a basic snippet attribute based on a comprehensive quality index value corresponding to the key content and a content length of the key content to generate the target snippet attribute.

The comprehensive quality index value is configured to characterize the satisfaction degree of the first search result to the search requirements.

For example, the comprehensive quality index value includes ranking position, content quality, relevance to search content and timeliness. The ranking position is the ranking position of the target search result in the comprehensive search result. The higher the ranking position, the higher the comprehensive quality index value. The content quality is configured to characterize the quality of detailed content. For example, the content quality may be the quality of pictures and/or texts contained in the detailed content. The picture quality can be characterized by at least one of the clarity of the picture, the information content of the picture content or the relevance between the picture content and the search content. The text quality can be characterized by at least one of the smoothness of the text, and the relevance between the text content or the search content, etc. The content quality can also be determined by a content evaluation model or content evaluation index in related art. The higher the content quality, the higher the comprehensive quality index value. Timeliness is configured to characterize the difference between the release time of the first search result and the current time. The smaller the time difference between the release time and the current time, the higher the comprehensive quality index value. The comprehensive quality index value can be determined by any one of ranking position, content quality, relevance to search content and timeliness, or by at least two of the above four items. In response to calculating the comprehensive quality index value from at least two items of ranking position, content quality, relevance to search content or timeliness, a corresponding weight value can be set for each item, and then the comprehensive quality index value can be obtained by weighting.

Specifically, after determining the first search result, the electronic device can obtain the comprehensive quality index value of the first search result and the content length of the key content contained therein through the way in the above description. Then, the target snippet attribute of the first search result is determined by combining the quality index value and the content length. In this way, the satisfaction degree of the first search result to the search requirements can also be taken into account while considering the key content, so as to obtain the target snippet attribute that adapts to the first search result better, and further improve the flexibility and dynamic degree of determining the target snippet attribute.

In an example, the adjusting a basic snippet attribute based on a comprehensive quality index value corresponding to the key content and a content length of the key content to generate the target snippet attribute comprises: in response to determining that the content length is greater than or equal to a preset length threshold and the comprehensive quality index value is greater than or equal to a preset quality threshold, increasing the basic snippet attribute to generate the target snippet attribute based on a difference between the comprehensive quality index value and the preset quality threshold, a difference between the content length and the preset length threshold and a snippet attribute threshold.

The preset length threshold is a preset critical value of content length. The preset quality threshold is a preset critical value of the comprehensive quality index value of the search result. Both the preset length threshold and the preset quality threshold can be set empirically, or set according to the basic snippet attribute and the number of search results that can be displayed on the search result page at one time. For example, the preset length threshold can be determined according to the snippet line number and/or the snippet area size in the basic snippet attribute. For another example, the preset quality threshold can be determined according to the comprehensive quality index value of the search results that rank in the middle in the search results that can be displayed on the search results page at one time. The above basic snippet attribute is a preset default snippet attribute, which can be determined according to the fixed snippet attribute in related art, for example, the basic snippet attribute is three lines of text and three pictures.

Specifically, in response to the comparison result obtained by the electronic device being that the content length is greater than or equal to the preset length threshold, and the comprehensive quality index value is greater than or equal to the preset quality threshold, it means that the quality of the detailed content of the first search result is high and the length of the key content contained therein is long, and more key content can be displayed in the snippet information at this time. Therefore, the electronic device can increase the basic snippet attribute, to expand the snippet line number and/or the snippet area size in the snippet information, enrich snippet typesetting information to obtain the target snippet attribute.

In order to make the matching degree between the target snippet attribute and the first search result higher, the increase amplitude can be determined according to the difference between the comprehensive quality index value and the preset quality threshold, the difference between the content length and the preset length threshold, and the snippet attribute threshold. For example, a smaller adjustment amplitude can be firstly determined from an adjustment amplitude corresponding to the difference between the comprehensive quality index value and the preset quality threshold and an adjustment amplitude corresponding to the difference between the content length and the preset length threshold. Then, a smaller value is determined from the smaller adjustment amplitude and the difference amplitude between the snippet attribute threshold and the basic snippet attribute. Then, according to the finally determined adjustment amplitude, the increase amplitude of the basic snippet attribute is determined. Finally, the basic snippet attribute is adjusted by using the determined increase amplitude to obtain the target snippet attribute.

In another example, the adjusting a basic snippet attribute based on a comprehensive quality index value corresponding to the key content and a content length of the key content to generate the target snippet attribute comprises: in response to determining that the content length is less than the preset length threshold, reducing the basic snippet attribute based on the content length to generate the target snippet attribute.

Specifically, in response to the comparison result obtained by the electronic device being that the content length is less than the preset length threshold, it means that the key content in the first search result belongs to a short answer. At this time, no matter how good or bad the first search result is, only short key content is needed to meet the search requirements. In this case, the electronic device can reduce the basic snippet attribute according to the content length to obtain the target snippet attribute, so that the target snippet information can display the short key content, which avoids the problem that displaying other worthless content will cause information interference to users, thus improving the user's information acquisition efficiency and screening efficiency of search results.

In another example, the adjusting a basic snippet attribute based on a comprehensive quality index value corresponding to the key content and a content length of the key content to generate the target snippet attribute comprises: in response to determining that the comprehensive quality index value is less than the preset quality threshold, determining the basic snippet attribute as the target snippet attribute or reducing the basic snippet attribute to generate the target snippet attribute.

Specifically, in response to the comparison result obtained by the electronic device being that the comprehensive quality index value is less than the preset quality threshold, it means that the quality of the first search result is poor, and the probability that it does not meet the user's search requirements is high. In this case, regardless of the content length of the first search result, there is no need to show too much content in the target snippet information. Therefore, the electronic device can take the basic snippet attribute as the target snippet attribute to maintain the normal snippet content. Alternatively, the electronic device can reduce the basic snippet attribute to obtain the target snippet attribute, so that short key content can be displayed in the target snippet information, so that the user can quickly filter out the first search result, thereby improving the user's screening efficiency of search results.

S630, performing information processing on the detailed content based on the target snippet attribute to generate snippet information corresponding to the first search result.

Specifically, the electronic device can use a reading comprehension model in the related art to extract the detailed content of the first search result to obtain the key content, and then continue to extract and sort out information of the key content according to the requirements of the target snippet attribute, to obtain the target snippet information.

The snippet information generation method provided by the embodiment of the present disclosure can determine an appropriate target snippet attribute for the first search result according to the key content matching the search content in the detailed content of the search result, and generate the target snippet information of the first search result according to the target snippet attribute and the detailed content of the search result, so that the snippet information of each first search result can be dynamically adjusted according to the detailed content of the corresponding first search result. Therefore, the user can know the key content of the first search result without jumping to the landing page of the first search result, so that the snippet information can directly meet the user's search requirements, which improves the preview guidance effect of the snippet information on the detailed content of the search result, thereby improving the user's screening efficiency of search results and the information acquisition efficiency.

In some embodiments, S630 can be implemented as the following steps A and B.

Step A, extracting key information from the detailed content to obtain initial snippet information.

Specifically, the electronic device can extract the key information from the detailed content of the first search result by using the reading comprehension model in the related art to obtain the key content as the initial snippet information.

Step B, sorting out the initial snippet information based on the target snippet attribute and a content screening condition to generate the snippet information.

The content screening condition is a condition for further screening the initial snippet information. In the embodiment of the present disclosure, the content screening condition includes a content type and/or other snippets of a third search result. The content type is the information type contained in the key content, for example, it can be at least one of text type, picture type or video type. The third search result comprises one or more continuous search results that correspond to the search content, which are adjacent to and ranked before the first search result. The other snippets are the snippet information of the third search result, and the generation way is the same as that of the snippet information in the embodiment of the present disclosure.

Specifically, the target snippet attribute is the definition of at least one of snippet line number, snippet area size or snippet typesetting of information the snippet information, which is the overall definition on the information. However, in order to improve the satisfaction degree of the snippet information to the search requirements, a content screening condition can also be set to screen from the perspective of content. In this way, after obtaining the initial snippet information, the electronic device can use the target snippet attribute to screen the initial snippet information from the perspective of data quantity, and use the content screening condition to screen the initial snippet information from the perspective of content, and finally get the snippet information through two layers of screening. Such snippet information can adapt to the first search result in terms of snippet length and snippet content, so as to accurately and comprehensively display the key content of the first search result, which further improves the satisfaction degree of the snippet information to the search requirements, and further improves the user's information acquisition efficiency and screening efficiency of the search results.

In an example, in response to the content screening condition being the content type, the above step B comprises: in response to a first proportion of picture type and/or video type in the content type being greater than or equal to a second proportion of text type in the key content type, intercepting text content in the initial snippet information to obtain first intermediate snippet information; in response to the first proportion being less than the second proportion, intercepting picture content and/or video content in the initial snippet information to obtain the first intermediate snippet information; intercepting the first intermediate snippet information based on the target snippet attribute to generate the snippet information.

The first intermediate snippet information is transitional snippet information obtained by screening the initial snippet information by using the content type.

Specifically, in response to the content screening condition is the content type, the electronic device can dynamically adjust the graphic proportion displayed in the snippet information.

The electronic device first counts the proportion of each content type comprised in the initial snippet information, that is, counts the first proportion of picture type and video type in all content types contained in the initial snippet information, and counts the second proportion of text type in all content types. Then, the first proportion and the second proportion are compared.

In response to the comparison result being that the first proportion is greater than or equal to the second proportion, it means that pictures and videos in the initial snippet information account for a larger proportion, which further means that the pictures and videos in the initial snippet information have better presentation effect on the content. At this time, the electronic device can retain more pictures and/or videos in the initial snippet information, and intercept the text content therein to obtain the first intermediate snippet information.

In response to the comparison result being that the first proportion is less than the second proportion, it means that the text in the initial snippet information accounts for a large proportion, which further means that the text in the initial snippet information has a better presentation effect on the content. Then, the electronic device can intercept the pictures and/or videos in the initial snippet information, and retain more text content therein to obtain the first intermediate snippet information.

Then, the electronic device uses the target snippet attribute to process the first intermediate snippet information from the perspective of the snippet length.

In response to the line number of the first intermediate snippet information being greater than the snippet line number in the target snippet attribute, or the display area size required by the first intermediate snippet information being greater than the snippet area size in the target snippet attribute, the electronic device can intercept the first intermediate snippet information as a whole according to the target snippet attribute, and the intercepted first intermediate snippet information can be taken as the hidden part of content, and the retained part of the first intermediate snippet information is determined as the snippet information.

In response to the line number of the first intermediate snippet information being less than or equal to the snippet line number in the target snippet attribute, or the display area size required by the first intermediate snippet information being less than or equal to the snippet area size in the target snippet attribute, the electronic device can directly determine the first intermediate snippet information as the snippet information.

In other embodiments, in response to the content screening condition being the other snippets, the above step B comprises: screening out repeated content in the initial snippet information based on the other snippets to generate second intermediate snippet information; intercepting the second intermediate snippet information based on the target snippet attribute to generate the snippet information.

The second intermediate snippet information is transitional snippet information obtained by screening the initial snippet information by using the other snippets.

Specifically, in order to further improve the information content displayed on the search result page, and further improve the information acquisition efficiency, in this embodiment, the other snippets can be used to screen the initial snippet information from the perspective of content, so as to determine the snippet information more dynamically.

After obtaining the initial snippet information, the electronic device obtains other snippets of at least one third search result. Then, the snippet contents of other snippets are used to screen out the repeated content of the snippet content in the initial snippet information, that is, the same or similar parts as those contained in the other snippets are removed from the initial snippet information, while the parts different from those contained in the other snippets are retained to obtain the second intermediate snippet information. Then, the electronic device uses the target snippet attribute to process the second intermediate snippet information from the perspective of snippet length. The processing procedure can refer to the above-mentioned process of processing the first intermediate snippet information by using the snippet information.

In still other embodiments, the electronic device can sort out the initial snippet information by using the content type and the other snippets to generate third intermediate snippet information; and intercept the third intermediate snippet information by using the target snippet attribute to generate the snippet information. That is, the content type and the other snippets are both used to adjust the graphic and text proportion of the initial snippet information and screen out the repeated content to get yet another intermediate snippet information (that is, the third intermediate snippet information). Then, the third intermediate snippet information is processed from the perspective of snippet length by using the target snippet attribute.

The following is an embodiment of the search result display apparatus provided by the embodiment of the present disclosure, which belongs to the same inventive concept as the search result display method of the above embodiments. For details not described in detail in the embodiment of the search result display apparatus, please refer to the embodiments of the above search result display method.

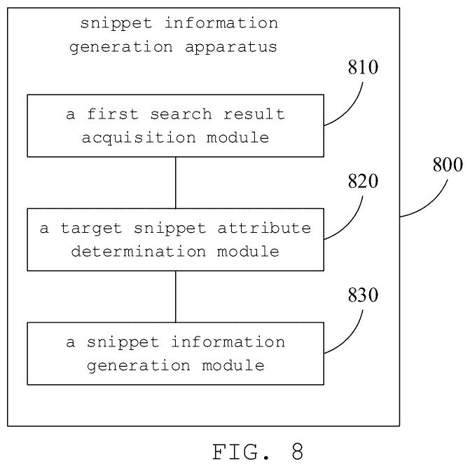

FIG. 7 shows a schematic structural diagram of a search result display apparatus provided by an embodiment of the present disclosure. As shown in FIG. 7, a search result display apparatus 700 may comprise:
a first search result acquisition module 710 for acquiring a first search result in response to search content;
a snippet information display module 720 for displaying snippet information corresponding to the first search result on a search result page; wherein: the snippet information is generated based on detailed content and a snippet attribute of the first search result; the snippet attribute comprises at least one of a snippet line number, a snippet area size and snippet typesetting information; and the snippet attribute is determined based on key content matching the search content in the detailed content.

The search result display apparatus provided by the embodiment of the present disclosure can determine an appropriate snippet attribute for the search result according to the key content matching the search content in the detailed content of the search result, and generate and display snippet information of the search result according to the snippet attribute and the detailed content of the search result, so that the snippet information of each search result can be dynamically adjusted according to the key content of the corresponding search result. Therefore, the user can know the key content of the search result without jumping to the landing page of the search result, so that the snippet information can directly meet the user's search requirements, which improves the preview guidance effect of the snippet information on the detailed content of the search result, thereby improving the user's screening efficiency of search results and the information acquisition efficiency.

In some embodiments, the snippet information display module 720 is specifically for:
displaying snippet information in a target style on a search result page, wherein the target style matches the snippet attribute.

In some embodiments, the snippet information display module 720 is also specifically for:
displaying an all-snippet viewing control at a display position of the snippet information in response to complete snippet content of the snippet information exceeding a snippet line number and/or a snippet area size;

Correspondingly, the search result display apparatus 700 further comprises a complete snippet display module which is for:
after displaying the snippet information in a target style on the search result page, displaying complete snippet content at a first preset position on the search result page in response to a trigger operation on the all-snippet viewing control.

In some embodiments, the snippet information display module 720 is specifically for:
in response to the key content comprising a plurality of key pictures, and an information amount of each key picture being greater than that of key text contained in the key content, or in response to the search content corresponding to a picture search intention and the key content comprising a plurality of key pictures, displaying a target number of key pictures comprised in the snippet information in a target display area corresponding to the snippet information on the search result page, wherein the target number is greater than a preset number.

Further, the snippet information display module 720 is specifically for:
displaying the target number of key pictures in the target display area in a display style that slides along a first preset direction to switch.

In some embodiments, the snippet information display module 720 is specifically for:
in response to an information amount of key text contained in the key content being greater than that of key pictures contained in the key content, displaying the key text in a target display area of the snippet information on the search result page according to an information display dimension corresponding to the key text, and displaying at least one key picture according to a preset picture position

In some embodiments, the snippet information display module 720 is specifically for:
in response to the key content comprising a key picture and the key picture meeting the search requirements corresponding to the search content, displaying the key picture in a target display area corresponding to the snippet information on the search result page, and an area proportion of a picture display area of the key picture in the target display area exceeds a preset proportion.

In some embodiments, the snippet information display module 720 is also specifically for:
displaying at least one of a resource download control, a resource use right identifier or a thumbnail in the detailed content in a target display area of the snippet information on the search result page.

In some embodiments, the search result display apparatus 700 further comprises a download progress display module which is for:
in response to the resource download control being displayed in the target display area, after displaying the snippet information in a target style on the search result page, hiding the resource download control in response to a trigger operation on the resource download control, and displaying resource download progress information at a display position of the resource download control.

In some embodiments, the snippet information display module 720 is also specifically for:
in response to the key content comprising a key picture, and an original display size of the key picture being larger than the snippet area size, displaying a thumbnail corresponding to the key picture in the target display area.

Correspondingly, the search result display apparatus 700 further comprises a key picture display module which is for:
after displaying the snippet information in a target style on the search result page, displaying the key picture at a second preset position of the search result page in response to a trigger operation on the thumbnail.

In some embodiments, the snippet information display module 720 is also specifically for:
displaying a plurality of sub-snippets in a display style that slides along a second preset direction to switch on the search result page; wherein the sub-snippet comprises a key picture in a second search result associated with the first search result and/or key text matching the search content.

Further, the search result display apparatus 700 further includes a detailed content display module which is for:
after displaying a plurality of sub-snippets in a display style that slides along a second preset direction to switch on the search result page, in response to a trigger operation on any sub-snippet, displaying detailed content of the second search result corresponding to the triggered sub-snippet at a third preset position on the search result page.

In some embodiments, the snippet attribute is determined based on a comprehensive quality index value corresponding to the key content and a content length of the key content; wherein the comprehensive quality index value is used to characterize a satisfaction degree of the first search result to the search requirements.

The search result display apparatus provided by the embodiment of the present disclosure can execute the search result display method provided by any embodiment of the present disclosure, and has corresponding functional modules for executing the method and beneficial effects.

The following is an example of a snippet information generation apparatus provided by an embodiment of the present disclosure, which belongs to the same inventive concept as the snippet information generation method of the above embodiment. For details not described in detail in the embodiment of the snippet information generation apparatus, please refer to the embodiment of the above snippet information generation method.

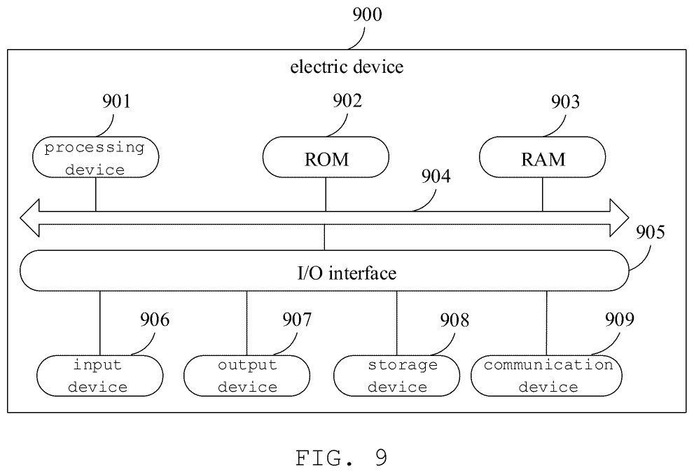

FIG. 8 shows a schematic structural diagram of a snippet information generation apparatus provided by an embodiment of the present disclosure. As shown in FIG. 8, a snippet information generation apparatus 800 may comprise:
a first search result acquisition module 810 for acquiring a first search result corresponding to search content;
a target snippet attribute determination module 820 for determining a target snippet attribute of the first search result based on key content of the first search result, wherein: the target snippet attribute comprises at least one of a snippet line number, a snippet area size or snippet typesetting information, and the key content is content matching the search content in detailed content of the first search result;
a snippet information generation module 830 for performing information processing on the detailed content based on the target snippet attribute to generate snippet information corresponding to the first search result.

The snippet information generation apparatus provided by the embodiment of the present disclosure can determine an appropriate target snippet attribute for the search result according to the detailed content of the search result, a comprehensive quality index value of the search result and a key content length of the search result, and generate the target snippet information of the search result according to the target snippet attribute and the detailed content of the search result, so that the snippet information of each search result can be dynamically adjusted according to the detailed content of the corresponding search result. Therefore, the user can know the key content of the search result without jumping to the landing page of the search result, so that the snippet information can directly meet the user's search requirements, which improves the preview guidance effect of the snippet information on the detailed content of the search result, thereby improving the user's screening efficiency of search results and the information acquisition efficiency.

In some embodiments, the target snippet attribute determination module 820 is specifically for:
adjusting a basic snippet attribute based on a comprehensive quality index value corresponding to the key content and a content length of the key content to generate the target snippet attribute; wherein the comprehensive quality index value is configured to characterize a satisfaction degree of the first search result to the search requirements.

Further, the target snippet attribute determination module 820 is specifically for generating the target snippet attribute in at least one of the following ways:
in response to determining that the content length is greater than or equal to a preset length threshold, and the comprehensive quality index value is greater than or equal to a preset quality threshold, increasing the basic snippet attribute based on a difference between the comprehensive quality index value and the preset quality threshold, a difference between the content length and the preset length threshold and a snippet attribute threshold, to generate the target snippet attribute;
in response to determining that the content length is less than the preset length threshold, reducing the basic snippet attribute based on the content length to generate the target snippet attribute; or
in response to determining that the comprehensive quality index value is less than the preset quality threshold, determining the basic snippet attribute as the target snippet attribute, or reducing the basic snippet attribute to generate the target snippet attribute.

In some embodiments, the comprehensive quality index value includes ranking position, content quality, relevance to search content and timeliness; among them, content quality is configured to characterize the quality of detailed content, and timeliness is configured to characterize the difference between the release time of the first search result and the current time.

In some embodiments, the snippet information generation module 830 comprises:
an initial snippet information acquisition submodule for extracting key information from detailed content to obtain initial snippet information;
an snippet information generation submodule for sorting out the initial snippet information based on the target snippet attribute and a content screening condition to generate the snippet information; wherein the content screening condition includes a content type and/or other snippets of a third search result; the content type is an information type contained in the key content, and the third search result comprises one or more continuous search results that correspond to the search content, which are adjacent to and ranked before the first search result.

In some embodiments, the snippet information generation submodule is specifically for:
in response to the content screening condition being content type, and a first proportion of picture type and/or video type in the content type being greater than or equal to a second proportion of text type in the content type, intercepting text content in the initial snippet information to obtain first intermediate snippet information;
in response to the first proportion being less than the second proportion, intercepting picture content and/or video content in the initial snippet information to obtain the first intermediate snippet information;
intercepting the first intermediate snippet information based on the target snippet attribute to generate the snippet information.

In some embodiments, the snippet information generation submodule is specifically for:
in response to the content screening condition being the other snippets, screening out repeated content in the initial snippet information based on the other snippets to generate second intermediate snippet information;
intercepting the second intermediate snippet information based on the target snippet attribute to generate the snippet information.

The snippet information generation apparatus provided by the embodiment of the present disclosure can execute the snippet information generation method provided by any embodiment of the present disclosure, and has corresponding functional modules for executing the method and beneficial effects.

It is worth noting that in the embodiments of the above-mentioned snippet information display apparatus and snippet information generation apparatus, the modules and submodules included are only divided based on functional logic, but it is not limited to the above-mentioned division, as long as the corresponding functions can be realized. In addition, the specific names of the functional modules/submodule are only for the convenience of distinguishing between each other, and are not used to limit the protection scope of the present disclosure.

Embodiments of the present disclosure also provide an electronic device, which may include a processor and a memory, and the memory may be used to store executable instructions. The processor can be used to read the executable instructions from the memory and execute the executable instructions to implement the steps of the search result display method or the snippet information generation method in any of the above embodiments.

When an electronic device is used to implement the steps of the search result display method in any of the above embodiments, the electronic device may be an electronic device installed with front-end search related applications, which may include, but is not limited to, a mobile terminal such as a smart phone, a notebook computer, a personal digital assistant (PDA), a tablet personal computer (Tablet PC), a portable multimedia player (PMP), a vehicle-mounted terminal (such as a vehicle navigation terminal), a wearable device, etc., and a fixed terminal such as a digital TV, a desktop computer, etc.

When an electronic device is used to implement the steps of the snippet information generation method in any of the above embodiments, the electronic device may be an electronic device that performs a back-end search function, which may be implemented as a single server or a server cluster.

FIG. 9 shows a schematic structural diagram of an electronic device provided by an embodiment of the present disclosure.

As shown in FIG. 9, the electronic device 900 may include a processing device (e.g., a central processer, a graphics processor, etc.) 901 that may perform various appropriate actions and processes according to a program stored in a read-only memory (ROM) 902 or a program loaded from a storage device 908 into a random access memory (RAM) 903. In the RAM 903, various programs and data necessary for the operation of the terminal device 900 are also stored. The processing device 901, the ROM 902, and the RAM 903 are connected to each other via a bus 904. An input/output interface (I/O interface) 905 is also connected to the bus 904.

Generally, the following devices can be connected to the I/O interface 905: an input device 906 including, for example, a touch screen, touch pad, keyboard, mouse, camera, microphone, accelerometer, gyroscope, etc.; an output device 907 including, for example, a Liquid Crystal Display (LCD), speaker, vibrator, etc.; a storage device 908 including, for example, magnetic tape, hard disk, etc.; and a communication device 909. The communication device 909 may allow the electronic device 900 to communicate with other devices wirelessly or by wire to exchange data.

It should be noted that the electronic device 900 shown in FIG. 9 is only an example, and should not bring any limitation to the functions and the scope of the application of the embodiment of the present disclosure. While FIG. 9 illustrates an electronic device 900 having various means, it is to be understood that it is not required to implement or provide all of the means shown. More or fewer means may be alternatively implemented or provided.

In particular, the processes described above with reference to the flow diagrams may be implemented as computer software programs, according to the embodiment of the present disclosure. For example, an embodiment of the present disclosure includes a computer program product comprising a computer program carried on a non-transitory computer readable medium, the computer program containing program code for performing the method illustrated by the flow diagram. In such an embodiment, the computer program may be downloaded and installed from the network via the communication device 909, or installed from the storage device 908, or installed from the ROM 902. When executed by the processing device 901, the computer program performs the above-described functions defined in the search result display method in any embodiment of the present disclosure, or performs the above-mentioned functions defined in the snippet information generation method of any embodiment of the present disclosure.

The embodiment of the present disclosure also provides a computer readable storage medium storing a computer program which, when executed by a processor, causes the processor to implement the steps of the search result display method in any embodiment of the present disclosure, or implement the steps of the snippet information generation method of any embodiment of the present disclosure.

It should be noted that the computer readable medium of the present disclosure may be a computer readable signal medium or a computer readable storage medium or any combination of the two. The computer readable storage medium may be, for example, but not limited to, an electronic, magnetic, optical, electro-magnetic, infrared, or semiconductor system, apparatus, or device, or any combination of the foregoing. More specific examples of the computer readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that contains, or stores a program for use by or in combination with an instruction execution system, apparatus, or device. In contrast, in the present disclosure, a computer readable signal medium may include a data signal propagated in a baseband or as a part of a carrier wave, wherein a computer readable program code is carried therein. Such a propagated data signal may take a variety of forms, including, but not limited to, an electro-magnetic signal, an optical signal, or any suitable combination thereof. A computer-readable signal medium may be any computer readable medium other than a computer-readable storage medium and the computer-readable signal medium can communicate, propagate, or transport a program for use by or in combination with an instruction execution system, apparatus, or device. Program code embodied on a computer-readable medium may be transmitted using any appropriate medium, including but not limited to: electrical wires, optical cables, RF (radio frequency), etc., or any suitable combination thereof.

In some embodiments, the client and the server can communicate using any currently known or future-developed network protocol, such as HTTP, and may be interconnected to digital data communication (e.g., a communication network) of any form or medium. Examples of communication networks include a local area network (“LAN”), a wide area network (“WAN”), the Internet (e.g., the Internet), and a peer-to-peer network (e.g., ad hoc peer-to-peer network), as well as any currently known or future developed network.

The computer readable medium may be included in the above-mentioned electronic device; or it may exist alone without being assembled into the electronic device.

The computer readable medium carries one or more programs which, when executed by the electronic device, cause the electronic device to perform the steps of the search result display method described in any embodiment of the present disclosure, or perform the steps of the snippet information generation method described in any embodiment of the present disclosure.

In the embodiment of the present disclosure, computer program code for carrying out operations of the present disclosure may be written in one or more programming languages or a combination thereof, the programming languages include, but are not limited to an object oriented programming language such as Java, Smalltalk, C++, and also include conventional procedural programming languages, such as the “C” programming language, or similar programming languages. The program code can be executed entirely on the user's computer, partly on the user's computer, as an independent software package, partly on the user's computer and partly executed on a remote computer, or entirely on the remote computer or server. In the scenario involving a remote computer, the remote computer may be connected to the user's computer through any type of network, including a Local Area Network (LAN) or a Wide Area Network (WAN), or may be connected to an external computer (for example, through the Internet using an Internet service provider).

The flow diagrams and block diagrams in the figures illustrate architectures, functionalities, and operations that are possibly implemented according to the apparatuses, methods and computer program products of various embodiments of the present disclosure. In this regard, each block in the flow diagrams or block diagrams may represent a module, program segment, or portion of code, which comprises one or more executable instructions for implementing the specified logical function(s). It should also be noted that, in some alternative implementations, the functions noted in the blocks may occur in an order different from that noted in the figures. For example, two blocks shown in succession may, in fact, be executed substantially concurrently, or they may sometimes be executed in a reverse order, depending upon the function involved. It will also be noted that each block of the block diagrams and/or flow diagrams, and a combination of blocks in the block diagrams and/or flow diagrams, can be implemented by special purpose hardware-based systems that perform the specified functions or operations, or combinations of special purpose hardware and computer instructions.

The functions described herein above may be performed, at least in part by one or more hardware logic components. For example, without limitation, exemplary types of hardware logic components that may be used include Field Programmable Gate Arrays (FPGAs), Application Specific Integrated Circuits (ASICs), Application Specific Standard Products (ASSPs), Systems on a Chip (SOCs), Complex Programmable Logic Devices (CPLDs), and so forth.

In the context of this disclosure, a machine readable medium may be a tangible medium that can contain, or store a program for use by or in combination with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination thereof. More specific examples e machine readable storage medium would include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The above descriptions are only preferred embodiments of the present disclosure and are illustrative of the principles of the technology employed. It will be appreciated by those skilled in the art that the scope of disclosure of the present disclosure is not limited to the technical solutions formed by specific combinations of the above-described technical features, and should also encompass other technical solutions formed by any combination of the above-described technical features or equivalents thereof without departing from the concept of the present disclosure. For example, the technical solutions formed by the above features be replaced with (but not limited to) features having similar functions disclosed in the present disclosure.

Further, although operations are depicted in a particular order, this should not be understood as requiring such operations to be performed in the particular order shown or in sequential order. Under certain circumstances, multitasking and parallel processing may be advantageous. Likewise, although several specific implementation details are included in the above discussion, these should not be construed as limitations on the scope of the present disclosure. Certain features that are described in the context of a single embodiment can also be implemented in combination in the single embodiment. Conversely, various features that are described in the context of a single embodiment can also be implemented in multiple embodiments separately or in any suitable subcombination.

Although the present subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A search result display method, comprising:
acquiring a first search result in response to search content; and
displaying snippet information corresponding to the first search result on a search result page, wherein: the snippet information is generated based on detailed content and a snippet attribute of the first search result; the snippet attribute comprises at least one of a snippet line number, a snippet area size or snippet typesetting information; and the snippet attribute is determined based on key content matching the search content in the detailed content.

2. The search result display method according to claim 1, wherein the displaying snippet information corresponding to the first search result on a search result page comprises:
displaying the snippet information in a target style on the search result page, wherein the target style matches the snippet attribute.

3. The search result display method according to claim 2, wherein:
the displaying the snippet information in a target style on the search result page comprises displaying an all-snippet viewing control at a display position of the snippet information in response to complete snippet content of the snippet information exceeding the snippet line number and/or the snippet area size; and
the method further comprises after the displaying the snippet information in a target style on the search result page, displaying the complete snippet content at a first preset position on the search result page in response to a trigger operation on the all-snippet viewing control.

4. The search result display method according to claim 2, wherein the displaying the snippet information in a target style on the search result page comprises:
in response to the key content containing a plurality of key pictures and an information amount of the plurality of key pictures being greater than an information amount of key text contained in the key content, or in response to the search content corresponding to a picture search intention and the key content containing a plurality of key pictures, displaying a target number of the plurality of key pictures comprised in the snippet information in a target display area corresponding to the snippet information on the search result page, wherein the target number is greater than a preset number;
optionally, the displaying a target number of the plurality of key pictures contained in the snippet information in a target display area corresponding to the snippet information on the search result page comprises:
displaying the target number of the plurality of key pictures in a display style that slides along a first preset direction to switch in the target display area.

5. (canceled)

6. The search result display method according to claim 2, wherein:
the displaying the snippet information in a target style on the search result page comprises:
in response to an information amount of key text contained in the key content being greater than an information amount of the plurality of key pictures contained in the key content, displaying the key text in a target display area of the snippet information of the search result page according to an information display dimension corresponding to the key text, and displaying at least one key picture according to a preset picture position; or
the displaying the snippet information in a target style on the search result page comprises:
in response to the key content containing a key picture and the key picture meets search requirements corresponding to the search content, displaying the key picture in a target display area corresponding to the snippet information of the search result page, wherein an area proportion of a picture display area of the key picture in the target display area exceeds a preset proportion; or
the displaying the snippet information in a target style on the search result page comprises:
displaying at least one of a resource download control, a resource use right identifier or a thumbnail in the detailed content in the target display area of the snippet information of the search result page.

7-8. (canceled)

9. The search result display method according to claim 6, further comprising:
in response to the resource download control being displayed in the target display area, after the displaying the snippet information in a target style on the search result page, hiding the resource download control in response to a trigger operation on the resource download control, and displaying resource download progress information at a display position of the resource download control.

10. The search result display method according to claim 6, wherein in response to the key content containing a key picture, and an original display size of the key picture being larger than the snippet area size, a thumbnail corresponding to the key picture is displayed in the target display area, and the method further comprises:
after the displaying the snippet information in a target style on the search result page, displaying the key picture at a second preset position on the search result page in response to a trigger operation on the thumbnail.

11. The search result display method according to claim 2, wherein the displaying the snippet information in a target style on the search result page comprises:
displaying a plurality of sub-snippets in a display style that slides along a second preset direction to switch on the search result page, wherein the sub-snippet contains a key picture in a second search result associated with the first search result and/or a key text matching the search content.

12. The search result display method according to claim 11, further comprising:
after the displaying a plurality of sub-snippets in a display style that slides along a second preset direction to switch on the search result page, in response to a trigger operation on any sub-snippet, displaying detailed content of the second search result corresponding to the any sub-snippet triggered at a third preset position on the search result page.

13. The search result display method according to claim 1, wherein the snippet attribute is determined based on a comprehensive quality index value corresponding to the key content and a content length of the key content, wherein the comprehensive quality index value is configured to characterize a satisfaction degree of the first search result to search requirements.

14. A snippet information generation method, comprising:
acquiring a first search result corresponding to search content;
determining a target snippet attribute of the first search result based on key content of the first search result, wherein: the target snippet attribute comprises at least one of a snippet line number, a snippet area size or snippet typesetting information, and the key content is content matching the search content in detailed content of the first search result; and
performing information processing on the detailed content based on the target snippet attribute to generate snippet information corresponding to the first search result.

15. The snippet information generation method according to claim 14, wherein the determining a target snippet attribute of the first search result based on key content of the first search result comprises:
adjusting a basic snippet attribute based on a comprehensive quality index value corresponding to the key content and a content length of the key content to generate the target snippet attribute, wherein the comprehensive quality index value is configured to characterize a satisfaction degree of the first search result to search requirements.

16. The snippet information generation method according to claim 15, wherein the adjusting a basic snippet attribute based on a comprehensive quality index value corresponding to the key content and a content length of the key content to generate the target snippet attribute comprises at least one of the following:
in response to determining that the content length is greater than or equal to a preset length threshold, and the comprehensive quality index value is greater than or equal to a preset quality threshold, increasing the basic snippet attribute based on a difference between the comprehensive quality index value and the preset quality threshold, a difference between the content length and the preset length threshold and a snippet attribute threshold to generate the target snippet attribute;
in response to determining that the content length is less than the preset length threshold, reducing the basic snippet attribute based on the content length to generate the target snippet attribute; or
in response to determining that the comprehensive quality index value is less than the preset quality threshold, determining the basic snippet attribute as the target snippet attribute, or reducing the basic snippet attribute to generate the target snippet attribute.

17. The snippet information generation method according to claim 15, wherein the comprehensive quality index value includes ranking position, content quality, relevance to the search content and timeliness, wherein the content quality is configured to characterize a quality of the detailed content, and the timeliness is configured to characterize a difference between a release time of the first search result and a current time.

18. The snippet information generation method according to claim 1, wherein the performing information processing on the detailed content based on the target snippet attribute to generate snippet information corresponding to the first search result comprises:
extracting key information from the detailed content to obtain initial snippet information; and
sorting out the initial snippet information based on the target snippet attribute and a content screening condition to generate the snippet information, wherein: the content screening condition comprises a content type and/or other snippets of a third search result; the content type is an information type contained in the key content; and the third search result comprises one or more continuous search results that correspond to the search content, which are adjacent to and ranked before the first search result;
optionally, in response to the content screening condition is the content type, the sorting out the initial snippet information based on the target snippet attribute and a content screening condition to generate the snippet information comprises:
in response to a first proportion of picture type and/or video type in the content type being greater than or equal to a second proportion of text type in the content type, intercepting text content in the initial snippet information to obtain first intermediate snippet information;
in response to the first proportion being less than the second proportion, intercepting picture content and/or video content in the initial snippet information to obtain the first intermediate snippet information; and
intercepting the first intermediate snippet information based on the target snippet attribute to generate the snippet information.

19. (canceled)

20. The snippet information generation method according to claim 18, wherein in response to the content screening condition is the other snippets, the sorting out the initial snippet information based on the target snippet attribute and a content screening condition to generate the snippet information comprises:
screening out repeated content in the initial snippet information based on the other snippets to generate second intermediate snippet information; and
intercepting the second intermediate snippet information based on the target snippet attribute to generate the snippet information.

21-22. (canceled)

23. An electronic device comprising:
a processor; and
a memory for storing executable instructions;
wherein the processor is for reading the executable instructions from the memory and executing the executable instructions to implement a search result display method, comprising:
acquiring a first search result in response to search content; and
displaying snippet information corresponding to the first search result on a search result page, wherein: the snippet information is generated based on detailed content and a snippet attribute of the first search result; the snippet attribute comprises at least one of a snippet line number, a snippet area size or snippet typesetting information; and the snippet attribute is determined based on key content matching the search content in the detailed content.

24. A non-transitory computer-readable storage medium storing a computer program, which, when executed by a processor, causes the processor to implement a search result display method according to claim 1.

25. (canceled)

26. An electronic device comprising:
a processor; and
a memory for storing executable instructions;
wherein the processor is for reading the executable instructions from the memory and executing the executable instructions to implement the search result display method according to a snippet information generation method according to claim 14.

27. A non-transitory computer-readable storage medium storing a computer program, which, when executed by a processor, causes the processor to implement a search result display method according to a snippet information generation method according to claim 14.
